(19) United States
(12) Patent Application Publication
(10) Pub. No.: US 2010/0109192 A1
(43) Pub. Date: May 6, 2010

(54) METHOD FOR SEALING A COMPLEX SHAPE ELECTRONIC SENSOR BY LOW-PRESSURE INJECTION OF REACTIVE RESIN

(75) Inventors: Armand Castandet, Pechabou (FR); Alix Courtadon, Toulouse (FR)

Correspondence Address: YOUNG & THOMPSON, 209 Madison Street, Suite 500, Alexandria, VA, 22314, US

(73) Assignee: CONTINENTAL AUTOMOTIVE FRANCE, TOULOUSE (FR)

(21) Appl. No.: 12/531,648

(22) PCT Filed: Mar. 10, 2008
(86) PCT No.: PCT/EP08/01885

§ 371 Date: Jan. 19, 2010

(30) Foreign Application Priority Data
Mar. 16, 2007 (FR) 0701913

(51) Int. Cl. B29C 45/14

(52) U.S. Cl. 264/272.14

(57) ABSTRACT

A method of sealing, by low-pressure injection of reactive resin, an electronic sensor placed in a housing consisting of at least two attached elements, includes the following steps:
i. assembly of the sensor within the elements of the housing,
ii. locking of the elements of the housing, in order to form an injection jacket,
iii. low-pressure injection of a reactive resin through at least one filling orifice of the injection jacket,
iv. continuing injection until the reactive resin overflows into at least one overflow container provided to contain the excess reactive resin, characterized in that filling orifice(s) and overflow container(s) are incorporated in the injection jacket.

The invention relates to a method of sealing an electronic sensor placed in a housing by low-pressure injection of reactive resin.

In order to protect the electronic components in an environment with severe ambient conditions (temperature and humidity for example), it is known to incorporate said electronic components and their connections in a watertight and protective assembly.

The present invention describes, by way of illustration that is in no way limiting in itself, a proximity sensor incorporated in a door handle of a motor vehicle. Such an electronic sensor is therefore subject to temperature and humidity conditions such that a premature aging and deterioration of the electronic components, even a disabling of them, are often observed in the absence of suitable protection means.

Those skilled in the art know that this problem can be resolved by means of a protective reactive resin coating said electronic components.

Thus, it is known to produce an element jacketing the electronic components and their associated connection that takes the form of a container, the container then being filled by gravity casting of a reactive resin, such as—for example—polyurethanes, epoxides or silicones.

This method has a notable disadvantage, which is its bulk. In practice, gravity casting requires the container to be overdimensioned in order to facilitate the casting and avoid overflows of reactive resin when coating the electronic components. In order to avoid overflows, a “dead volume” is thus systematically provided in the container which generates a certain bulk for the assembly.

Furthermore the gravity method cannot be used to fill products of complex shapes without once again generating an overdimensioning of the container in order to be able to suitably fill all the volumes.

Now, the current sensors tend to be miniaturized and their shapes are tending to become more and more complex in order to be better incorporated in their immediate environment. Thus, a sensor incorporated in a door handle of a motor vehicle must be able to best hug the shapes of said handle without making the latter too voluminous. It is therefore necessary to combine complex shapes with restricted dimensions, something that overmolding by gravity casting does not allow.

In order to resolve this problem, those skilled in the art have several known solutions available. The first consists in not using overmolding and in placing the electronic in a housing that is filled with air and watertight to the outside. Now, the seal-tightness of series-produced parts is difficult to guarantee, if only because the electrical power supply or signal transmission conductors of the sensor need to penetrate inside said housing and therefore, consequently, generate as many potential sources of rupture of the seal-tightness. The second technique consists in overmolding under pressure the electronic part using a thermoplastic material or a reactive two-component material (generically called RIM, an acronym standing for “Reaction Injection Molding”). This requires heavy investment, as much in molds as in machines, which makes this alternative prohibitive when it comes to cost. Furthermore, the injection of thermoplastic materials is generally done in high-pressure and high-temperature conditions that the electronic components do not easily withstand. Moreover, these materials do not have very good qualities of resistance over time given a humid atmosphere. Finally, such an overmolding can imprison air bubbles, detrimental to the seal-tightness of said overmolding.

The present invention aims to remedy the above problems, and at a contained cost.

To this end, the invention firstly targets a method of sealing, by low-pressure injection of reactive resin, an electronic sensor placed in a housing consisting of at least two attached elements, comprising the following steps:
i. assembly of the sensor within the elements of the housing,
ii. locking of the elements of the housing, in order to form an injection jacket,
iii. low-pressure injection of a reactive resin through at least one injection jacket filling orifice,
iv. continuing injection until the reactive resin overflows via at least one discharge orifice into at least one overflow container provided to contain the excess reactive resin,
   said method being characterized in that filling orifice(s) and overflow container(s) are incorporated in the injection jacket.

Thus, the low-pressure injection is done within an already-existing part which forms a casting mold, provided with at least one filling orifice and one orifice for discharging the injected surplus, with no risk of leak other than into the overflow container provided facing the discharge orifice. Furthermore, the low pressure does not impair the electronic components.

Advantageously, the method also comprises a subsequent step during which the filling orifice(s) and the overflow container(s) are separated from the injection jacket.

Thus, the finished part has an esthetic appearance and a reduced bulk, the two elements (filling orifice and overflow container) required for the sealing according to the invention being eliminated.

In one embodiment, the filling orifice(s) and the overflow container(s) have areas of weakness favoring their separation from the injection jacket.

It is then easy to separate the two types of element from the injection jacket in an industrial and reliable manner.

Preferably, the overflow container(s) comprise means facilitating the flow of the reactive resin, so enabling the low-pressure injection surplus to flow well.

Furthermore, the reactive resin used is from the family of polyurethanes.

Advantageously, the reactive resin used has a viscosity greater than 7000 mPa·s upon its injection in the step iii and greater than 10 000 mPa·s at the end of the step iv.

It is thus possible to ensure easy casting with a pressure that is not very high (between 1 and 1.5 bar overpressure in line with the filling orifice) and not to damage the electronic components with a very high viscosity.

Other features, aims and benefits of the invention will emerge from the detailed description that follows, given with reference to the appended drawings which represent a preferred embodiment thereof as a nonlimiting example. In these drawings:

FIG. 1 is a three-dimensional representation of a sensor according to the invention,

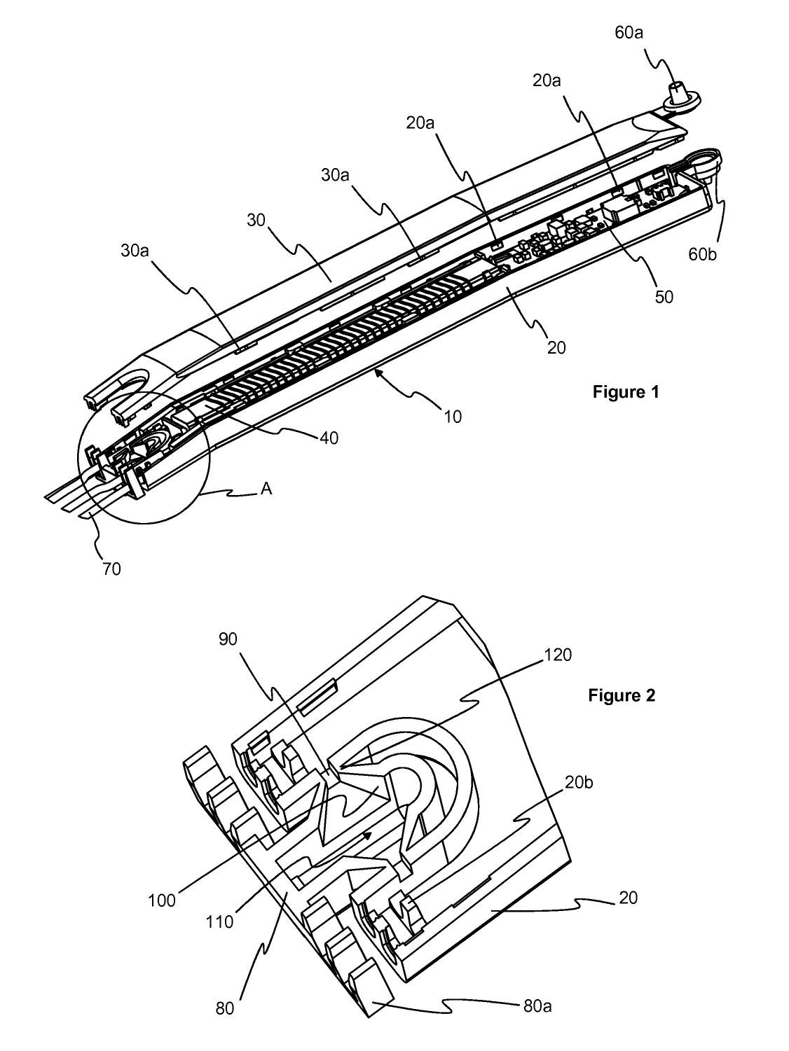

FIG. 2 is an enlargement of the area A of FIG. 1 of the bottom half-housing of a sensor according to the invention,

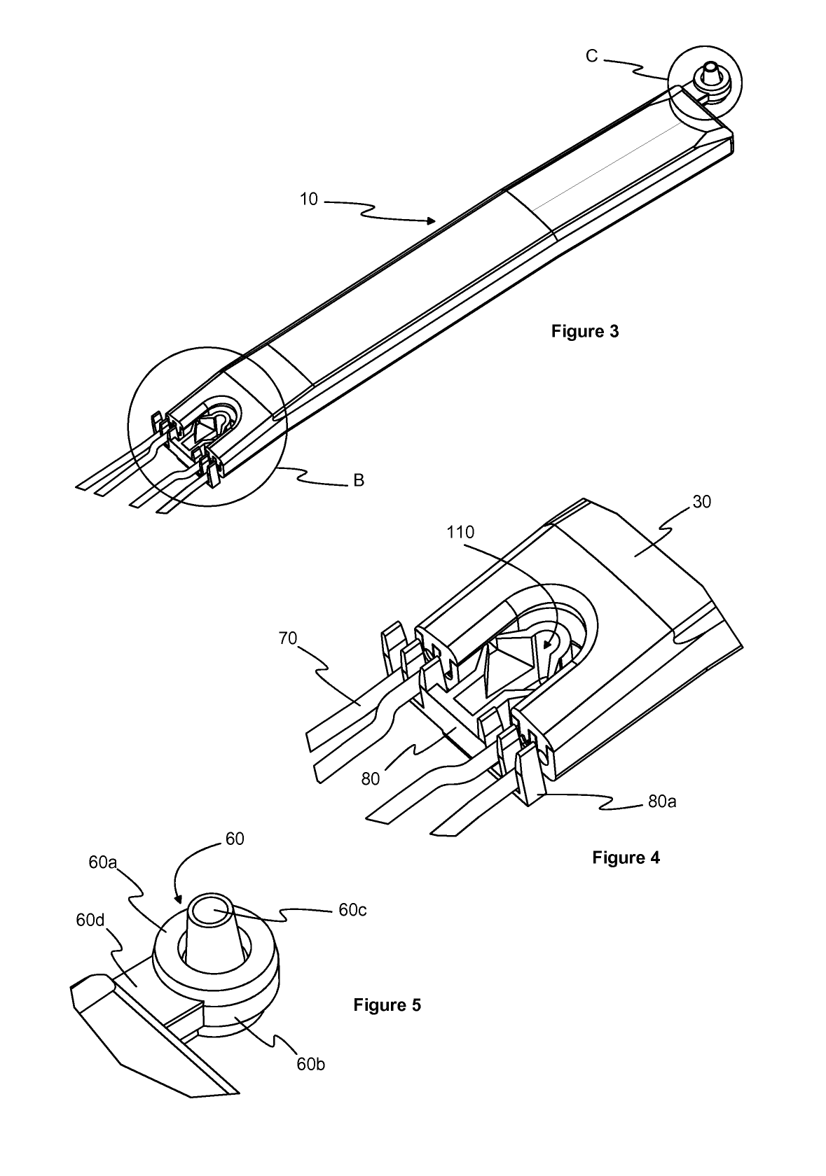

FIG. 3 is a three-dimensional representation of a sensor according to the invention, assembled, before the low-pressure resin injection step,

FIG. 4 is an enlargement of the area B of FIG. 3, showing the resin overflow container,

FIG. 5 is an enlargement of the area C of FIG. 3, showing the filling orifice,

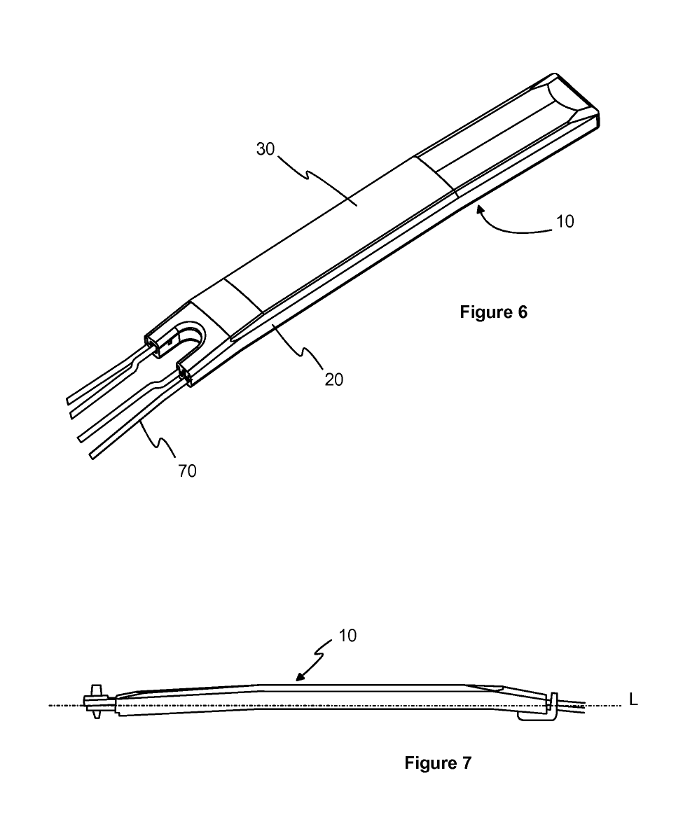

FIG. 6 is a three-dimensional view of a sensor according to the invention in its final production step, once the filling orifice and overflow container have been eliminated,

FIG. 7 is a side view of a sensor according to the invention.

The embodiment presented is that of a proximity sensor intended for incorporation in a door handle of a motor vehicle.

It is commonplace for motor vehicles to be equipped with an electronic device making it possible to identify with certainty the people approaching said vehicle in order to allow access inside the vehicle reserved only to duly authorized people. The means implemented to achieve this aim may vary, but the basic principle (reviewed here) is as follows:
the vehicle is equipped with means of identifying the approach of authorized people (generally wearing an electronic badge capable of securely dialoging with the identification means,
when an authorized person approaches, the identification means nevertheless wait for said person to actually manifest the intention of entering before unlocking the opening or openings of the vehicle. The aim of this twofold check is to enable—for example—an authorized person to pass very close to his vehicle without systematically unlocking access thereto.

In this device, one of the means used to determine the actual intention of the authorized person to re-enter into the vehicle consists in placing, in the handle of the openings, a proximity sensor which will enable the identification means to know that the authorized person is extending his hand toward the handle.

It is this type of sensor that will be described in more detail in the description.

Such a sensor type, incorporated in the vehicle (in this case in the handle of the opening), is, for example, of the capacitive type, and sends a proximity detection signal to the identification means. If the twofold condition stated previously is fulfilled (detection of authorization in the form of a badge for example and detection of a part of the body—generally a hand—close to the handle of the opening), then unlocking takes place and access is authorized.

The construction of a sensor 10 according to the invention is detailed with reference to FIG. 1.

It comprises a bottom half-housing 20 and a top half-housing 30 cooperating together via mechanical locking means 20a, 30a in order to produce an injection jacket in this way. Inside said injection jacket, there is placed the antenna 40 of the sensor 10 which is designed to detect proximity, and the electronic components 50 responsible for processing the information and sending a signal to the identification means (not represented). In order to power the sensor and route the detected signal, electrical conductors 70 also penetrate inside the injection jacket. As illustrated in FIG. 2, the bottom half-housing 20 has guides 20b allowing for an optimum positioning of the electrical conductors 70 and holding them in position.

Said injection jacket can be produced by injecting plastic, thermoplastic or thermosetting material, but not necessarily. It is quite possible to envisage a jacket made from another type of material (metal for example).

The top 30 and bottom 20 half-housings incorporate two elements 60a, 60b forming the filling orifice 60. This filling orifice 60 is used to direct the reactive resin toward the injection jacket in a leaktight manner. For this, all that is needed is to place a resin injection nozzle on the top element 60a.

Once assembled, the sensor appears as represented in FIG. 3. It then appears in the form of a monolithic part linked by electrical conductors 70 to the vehicle's electrical cable loom.

As represented in FIG. 5, the resin injection is carried out via the filling orifice 60 and more specifically, the injection nozzle cooperates with the resin inlet cone 60c. The channel for the introduction of the resin 60d, also visible in FIG. 1, then guides the reactive resin toward the interior of the injection jacket, in contact with the elements to be overmolded. At this stage of the method, the reactive resin is very fluid (its viscosity is advantageously greater than 7000 mPa·s at the filling orifice 60). It will start to harden to reach, at the end of the injection step and once the overflow container 80 is filled, a viscosity greater than 10 000 mPa·s.

The next step of the method consists in continuing the injection until the reactive resin overflows through the overflow container 80 provided for this purpose. The resin will therefore advance inside the injection jacket sufficiently slowly (an injection time of between 30 s and 1 min is usual, depending on the shape of the sensor 10 and the volume of resin to be injected) not to damage the electronic components 50. This is due to the combination of the relatively low viscosity and the low-pressure injection (between 1 and 1.5 bar at the injection orifice 60). This wall of resin will, as it advances, drive out the ambient air which will be able to escape via the overflow container 80.

Advantageously, the electronic components are placed close to the injection orifice 60 in order to always be subject to a resin that has a lower viscosity.

Also advantageously, the overflow container 80 is placed at the end of the advance of the reactive resin within the injection jacket.

Throughout the injection phase, the sensor is placed in a jig which will hold in position the two half-housings 20, 30 and ensure that the mechanical locking of the means cooperating to this end 20a, 30a does not yield, which would lead to leaks and render the sensor non-compliant.

In the embodiment illustrated, the resin is also used as a glue for the elements of the injection jacket.

At the end of the injection phase, as illustrated in FIGS. 2 and 4, the resin will leave the injection jacket through the only leak orifices 90 provided for this purpose. These leak orifices 90 open out into the overflow container 80, which is provided to accommodate the excess material within its reservoir 110.

Advantageously, the overflow container 80 has a pouring cone 100 facing the leak orifices 90, so that the resin is poured more easily and does not block said leak orifices 90. The resin will thus fill the reservoir 110 of the overflow container 80 without otherwise soiling the toolage. The injection parameters are optimized in order to fill said reservoir 110 without overflow.

It should be noted that the overflow container 80 can include guides 80a in order to facilitate the positioning of the electrical connectors 70, as represented in FIGS. 1, 2 and 4 in particular.

The next step is to separate the filling orifice 60 and the overflow container 80 from the rest of the sensor in order to obtain a functional sensor 10 as represented in FIG. 6.

According to a preferred embodiment, this separation operation is favored by shapes and lessened thicknesses in line with the point of separation 120. Thus, the force needed to provoke the separation is minimal and the break made systematic by the creation of these areas of lesser rigidity.

In order to highlight the benefit of the method according to the invention compared to a gravity casting method, FIG. 7 represents a side view of a sensor 10 according to the invention. The line L represents the maximum level reached for the given sensor if gravity casting were used to fill the bottom half-housing 20. It can thus immediately be seen that the electronic components 50 and the antenna 40 could not be totally overmolded and that the seal-tightness sought would not be achieved.

The present invention is not limited to the single embodiment described, but covers any adaptation within the scope of those skilled in the art.

More complex shapes can easily be imagined, for example, without in any way departing from the present invention. It is also possible to envisage an injection jacket consisting of more than two elements, or indeed one (or more) filling orifice(s) 60 placed in the middle of the injection jacket provided with a plurality of overflow containers 80.

1. A method of sealing, by low-pressure injection of reactive resin, an electronic sensor placed in a housing consisting of at least two attached elements, comprising the following steps:
i. assembly of the sensor within the elements of the housing,
ii. locking of the elements of the housing, in order to form an injection jacket,
iii. low-pressure injection of a reactive resin through at least one injection jacket filling orifice,
iv. continuing injection until the reactive resin overflows into at least one overflow container provided to contain the excess reactive resin,
characterized in that filling orifice(s) and overflow container(s) are incorporated in the injection jacket.

2. The sealing method as claimed in claim 1, characterized in that it also comprises a subsequent step during which the filling orifice(s) and the overflow container(s) are separated from the injection jacket.

3. The sealing method as claimed in claim 2, characterized in that the filling orifice(s) and the overflow container(s) have areas of weakness favoring their separation from the injection jacket.

4. The sealing method as claimed in claim 1, characterized in that the overflow container(s) comprise means facilitating the flow of the reactive resin.

5. The sealing method as claimed in claim 1, characterized in that the reactive resin used is from the family of polyurethanes.

6. The sealing method as claimed in claim 1, characterized in that the reactive resin used has a viscosity greater than 7000 mPa·s upon its injection in the step iii and greater than 10 000 mPa·s at the end of the step iv.
